(19) United States
(12) Patent Application Publication
(10) Pub. No.: US 2015/0154646 A1
(43) Pub. Date: Jun. 4, 2015

(54) STORAGE, RETRIEVAL, ANALYSIS, PRICING, AND MARKETING OF PERSONAL HEALTH CARE DATA USING SOCIAL NETWORKS, EXPERT NETWORKS, AND MARKETS

(71) Applicants: NEW YORK UNIVERSITY, New York, NY (US); SEQSTER, INC, San Diego, CA (US)

(72) Inventors: Bhubaneswar Mishra, Great Neck, NY (US); Sean White, Mountain View, CA (US); Dana Hosseini, San Diego, CA (US); Ardavan Arianpour, San Diego, CA (US)

(21) Appl. No.: 14/407,518

(22) PCT Filed: Jun. 14, 2013
(86) PCT No.: PCT/US13/46008

§ 371 Date: Dec. 12, 2014

Related U.S. Application Data
(60) Provisional application No. 61/660,602, filed on Jun. 15, 2012.

(51) Int. Cl. G06Q 30/02; G06Q 50/22; G06F 19/00

(52) U.S. Cl. CPC G06Q 30/0269; G06F 19/322; G06Q 30/0215; G06Q 30/0257; G06F 19/3418; G06F 19/3431; G06Q 50/22

(57) ABSTRACT

Systems and processes are provided for securely storing, retrieving, sharing, and selling private data, such as genome wide sequences, sequence related metadata, electronic healthcare data, biological data, demographic data, medical data, and other biomedical data, which, in turn, may allow the usage of genomic variations at multiple scales and across multiple population strata. In some examples, users may be matched with healthcare experts based on a medical need or interest. In other examples, an information-based market for utilizing the available data in a privacy-preserving manner may be provided. In these examples, individual or group data may be tracked, compared, rated, analyzed, and priced to allow individuals to establish connections and/or carry out financial transactions using their data with other participants, healthcare practitioners, and businesses.

### CROSS-REFERENCE TO RELATED APPLICATIONS

This application claims priority to U.S. Provisional Patent Application Ser. No. 61/660,602, filed Jun. 15, 2012, the entire disclosure of which is hereby incorporated by reference in its entirety for all purposes as if put forth in full below.

### BACKGROUND

1. Field

This application relates generally to data recording and, more specifically, to securely storing, retrieving, sharing, and selling private data, such as biological, demographic, health care, and medical data.

2. Related Art

Current estimates put U.S. health care spending at more than 17 percent of GDP and expect the health care share of GDP to continue its historical upward trend, reaching 19.5 percent of GDP by 2017. In 2007, an estimated U.S. $2.26 trillion was spent on health care in the U.S., or U.S. $7,439 per capita. Of each dollar spent on health care in the U.S., 31 percent went to hospital care, 21 percent went to physician services, 10 percent went to pharmaceuticals, 8 percent went to nursing homes, 7 percent went to administrative costs, and 23 percent went to all other categories (e.g., diagnostic laboratory services, pharmacies, medical device manufacturers, etc.). Thus, a bio-medical-information-based system that can effectively reduce the cost of each of these sectors will have an enormous impact on the nation's economy.

Individuals within society possess information that, when properly shared, may generate substantial social capital that can reduce the aggregate cost of many social benefits, including healthcare, which would lead to commensurate reduction in individuals' burdens. In the context of healthcare, such sharing may involve many individuals' biomedical data needed for, but not limited to, clinical trial and drug discovery; new data-intensive genome-based research carried out by for-profit or non-profit organizations; data-driven proactive, predictive, preventive, and personalized medicine; evidence-based medicine to popularize successful therapeutics; early detection of adversarial drug interactions and side effects; or social pressure to avoid unhealthy behavior (e.g., smoking) or encourage healthy behavior (e.g., exercise).

In the current setting, individuals that share such information voluntarily seldom acquire any direct financial benefits of significant value, as would be the case if their information could be priced and capitalized properly. Current processes, which only incentivize the primary and critical data sources suboptimally, leave the potentially larger social capital ultimately unexploited.

Furthermore, the contents of personal data, including healthcare and related data, are intimately associated with an individual's position and freedom within the society and are normally kept private to the individual and, when necessary, possibly to his closest social group (e.g., spouse and children). Thus, the privacy and transparency requirements for an individual within the society conflict naturally with the need for creating collective social data that can help the society as a whole.

There has been a rapid growth and proliferation of social networking sites, such as Facebook, Google+, PatientsLikeMe, and Twitter. It is indicative by its integration into the daily lives of people around the world irrespective of cultural norms and values. Its potential transformative and disruptive ability, in a different context (e.g., political), is now being witnessed with the use of social networking sites in bringing about social and political change in a number of countries. However, there has not been any explicit attempt in these systems to create a social capital, let alone create a social capital that allows the participants to enjoy revenue-sharing while retaining their privacy and protecting their freedoms.

Existing social networking sites only offer users ways to communicate via the Internet through their PCs or on their mobile devices (e.g., Internet telephony, texts, broadcasts, short tweets, followerships, etc). The most popular of these social networks allow users to simply and easily create their own profile and display an online network of contacts or “friends.” Users of these sites then identify additional contacts through similarity of certain characteristics or through association with their friends. As with other communication tools, social media has evolved certain rules, conventions, policies, and practices that users themselves have shaped to facilitate communications while avoiding consequences of publicly posting sensitive personal information or inadvertently including comments to unintended recipients. Within the social network environments, users have become familiar with sharing personal information, personal preferences, and medical information including treatments and outcomes. Users have sought out others with similar conditions in order to initiate, dialogue, and learn from each other's experience. Applications of social networking to track, store, and share health care information are proliferating with the growth in mobile devices and peripherals capable of monitoring vital longitudinal health information from heart rate to blood glucose. Further, social networking is also finding its way into the genetic testing market by offering genetic testing services and analysis of participant samples. For example, participants may contact other participants that are genetically similar and results estimating the genetic risks for any specific participant with respect to any specific diseases may be provided. However, these separate offerings are not integrated such that the individuals have full control of their information across systems. The reference found at http://ftc.gov/opa/2011/11/privacysettlement.shtm provides more details on this aspect of social networking systems.

A problem with all social networking sites is a lack of a balance between privacy and transparency, for example, when personal data and search data are being asymmetrically priced, used, and capitalized. Participants in social networking sites often do not adequately understand their privacy rights nor do they actively control their privacy, thus leaving them, at best, without remuneration for access to their data and, at worst, vulnerable to data theft. There is no audit process to validate and certify that an organization in possession of private data follows its own stated privacy rules. This problem has recently attracted attention from both the popular press as well as learned academic literature. For example, the reference found at http://trak.in/tags/business/2012/06/11/linkedin-privacy-issues/ describes this problem.

### SUMMARY

Various embodiments directed to managing personal data within a network are provided. One example method for managing personal data within a network may include storing user data for a plurality of users in one or more databases; receiving a request for a subset of the user data, wherein the request comprises one or more subject criteria and a price to be paid for the subset of user data; comparing the one or more subject criteria with user data associated with at least a portion of the plurality of users to identify a matching set of users; and sending a notification to the users of the matching set of users indicating that a match has been detected between the request for the subset of the user data and their respective user data.

In some examples, the method may further include receiving, from a user of the matching set of users, an authorization to share at least a portion of the user's data with an entity submitting the request for the subset of the user data in exchange for a financial or non-financial reward, wherein the financial or non-financial award is based at least in part on the price to be paid for the subset of user data defined by the request.

In some examples, the user data may include one or more of genome wide sequences, sequence related metadata, electronic healthcare data, biological data, demographic data, medical data, and other biomedical data.

In some examples, the price to be paid for the subset of user data may include a known price for a type of the subset of user data, a price for a similar type of data, or an arbitrarily selected price.

In some examples, identities of the plurality of users may not be revealed to an entity submitting the request for the subset of the user data when comparing the one or more subject criteria with the user data associated with the at least a portion of the plurality of users.

Another example method for managing persona data within a network may include storing user data for a plurality of users in one or more databases, wherein the user data comprises medical data; receiving, from a first user of the plurality of users, a request to be matched to a second user of the plurality of users, wherein the request comprises one or more matching criteria, and wherein the second user comprises a heath care professional; comparing the one or more matching criteria with user data associated with data associated with at least a portion of the plurality of users to identify a matching set of users from the at least a portion of the plurality of users, wherein the matching set of users comprises the second user; and generating a ranked list comprising the matching set of users.

In some examples, the method may further include transmitting a notification to the first user and at least a portion of the matching set of users indicating that a match has been detected between the first user and at least a portion of the matching set of users. In other examples, the method may further include receiving, from the first user, a selection of the second user; receiving, from the second user, a selection of the first user; and facilitating communication between the first user and the second user.

In some examples, the method may further include comparing user data associated with the first user with user data associated with other users to identify potential mental health risks, potential cognitive decline, or potential sense decline.

In some examples, each of the at least a portion of the plurality of users may be a health care professional and the at least a portion of the plurality of users authorized their associated user data to be publicly available.

Systems and computer readable storage media for performing the above mentioned methods are also provided.

### BRIEF DESCRIPTION OF THE FIGURES

FIG. 1 is a block diagram of an example system for securely storing, retrieving, sharing, and selling private personal data.

FIG. 2 illustrates an example interface for showing a user's social network.

FIG. 3 is an example interface for collecting user information.

FIG. 4 is a flow diagram illustrating an example process for matching a user with one or more experts.

FIG. 5 is a flow diagram illustrating an example process for implementing an information-based marketplace.

FIG. 6 illustrates an example interface for showing an information-based clinical trials market.

FIG. 7 illustrates an example computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below for securely storing, retrieving, sharing, and selling private data, such as genome wide sequences, sequence related metadata, electronic healthcare data, biological data, demographic data, medical data, and other biomedical data, which, in turn, may allow the usage of genomic variations at multiple scales and across multiple population strata. In some examples, users may be matched with healthcare experts based on a medical need or interest. In other examples, an information-based market for utilizing the available data in a privacy-preserving manner may be provided. In these examples, individual or group data may be tracked, compared, rated, analyzed, and priced to allow individuals to establish connections and/or carry out financial transactions using their data with other participants, healthcare practitioners, and businesses.

### A. System Description

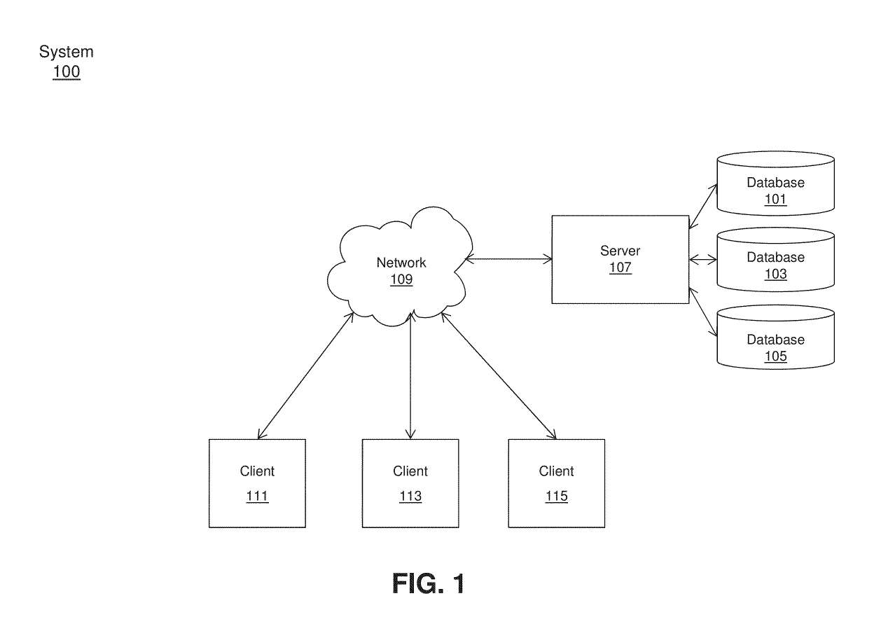

FIG. 1 illustrates an example system 100 for securely storing, retrieving, sharing, and selling private personal data. System 100 can be used to match users with healthcare experts for the purpose of providing health care services. System 100 can further be used to connect a large number of individuals wishing to share certain elements of their personal data with other individuals, health care practitioners, and businesses that wish to purchase those elements in a secure market place at known prices that, for example, may be set by an auction, a market-maker, or a dynamic pricing model.

In some examples, system 100 may generally include three major conceptual components. The first component of system 100 may be a privacy-preserving social network that can connect a large number of distributed individual databases, implemented using mobile devices, portable or desktop computers, and/or cloud-based computing systems. The second component may be a network of healthcare experts (e.g., daycare providers, healthcare providers, medical emergency personnel, genetic counselors, marriage counselors, fertility advisers, nutritionists, doctors, veterinarians, schools, universities, workplaces, gyms, hospitals, nursing homes, funeral homes, etc.). The third component may be an information-based market that can be used by a diverse set of entities (e.g., individuals, healthcare insurers, public-health organizations, preventive medicine advisors, healthcare providers, genetic researchers (academic or otherwise), pharmaceutical companies, non-governmental organizations, charities, governments, etc.) to provide and consume private personal data. Using the information-based market, these entities may be granted improved access to important personal data from a large group of well-selected individuals, who may then be persuaded to trade their personal information in exchange for financial or reputational rewards. The market may also enable other traders and investors to be involved in trading risk exposures from one group to another (e.g., from a risk-aversive group to a risk-bearing group, by use of swaps, futures, forwards and other derivatives).

As shown in FIG. 1, system 100 may include one or more persistent databases 101, 103, and 105 for storing key-value pairs representing personal data, such as genome wide sequences; sequence related metadata; electronic healthcare data; biological data; demographic data; temporal or spatio-temporal data; genomic, epigenomic, transcriptomic, proteomic, metabolomic, lipid, serum, etc. data (e.g., from peripheral bkxxlood, tissue samples, tumor samples, amnioscentic fluid, sperms, eggs, fertilized eggs, naturally or artificially aborted embryos, biopsies, autopsies, forensic materials, etc.); data collected longitudinally through health-games (physical, mental, emotional, etc.), played individually, socially, against an expert, etc.; financial data; legal transaction data; documents; or other medical data. In some examples, the data may be encrypted, time-stamped, authenticated, sealed, notarized, or protected under copyrights or privacy rights. Additionally, the data may be backed-up and mirrored in multiple locations.

Since the data stored in databases 101, 103, and 105 may be associated with their respective owners, the following non-exhaustive list of example uses of the data may be performed: prediction and intervention in the progression of a disease using longitudinal patient data; nutritional profiling and persuasive intervention; coordination and scheduling of individual and social activities (e.g., in a school, a gym, or a nursing home) for a healthy lifestyle; efficiently rewarding an individual or a group of patients for behavior modification using preventive medicine connected to financial tools; evidence-based competitive pricing of healthcare costs; efficient reduction of healthcare costs by identifying unproductive therapeutic intervention and/or biomedical tests; designing improved clinical trials by better recruitment of probands, pedigrees, trios and/or quartos (father, mother, one or two siblings), and case-controls with a market-driven efficient reward and incentive process; delineate genetic linkages and ancestry using genomics data and biomarkers to enable proactive, predictive, preventive, personalized, and evidence-based medicine to recommend genetic counseling and counselors; identify suitable marital opportunities; etc.

The data contained in databases 101, 103, and 105 may be owned by each individual such that an individual may decide to stay in full control of his data, decide to keep all or a portion of his own data private, knowledgeably exchange his data without infringing his inalienable rights, and make financial gain while helping his society to achieve greater goods. For example, an equitable sharing of the results of a clinical trial can take the form of a “reach-through” to the royalties on the diagnostics, drugs, and therapies developed from a clinical trial in which an individual participated. Furthermore, a liquid market in “reach-throughs,” for example, using such financial instruments as futures, forwards, and other similar derivatives, when available, may create an efficient market-place for pricing the future-benefits of a clinical-trial as well as the roles the participants' information played in it. Such a structure is expected to make it more attractive for each individual in the society to assume an increasingly bigger role in generating the social capital.

In some examples, users may input their personal data directly into databases 101, 103, and 105 and control its access directly or designate a proxy (such as a family member or the individual's health care provider, for instance belonging to his expert network), who may control all or a selected portion of the personal information. Those granted access to the data may be under legal obligation to use the data in certain specific manner; or to retain it under specified security requirements and only for certain period of time and to destroy the data in an irreversible manner when requested. The proxy may use the result from the analysis of the received data in a specified manner and only under certain financial, ethical, and moral obligations to the owner.

System 100 may further include server 107 coupled to databases 101, 103, and 105 to programmatically access the databases via secure and authenticated communications. Server 107 and databases 101, 103, and 105 can be set up in a cloud architecture to provide a highly available, scalable, and flexible database. This architecture may provide a basic API for accessing the databases through http or https messages via a server 107. As will be discussed in further detail below, server 107 may be configured to match individuals with other individuals, experts, businesses, or other consumers of information-based on user preferences and user metadata. Server 107 may be configured to restrict access to data stored in databases 101, 103, and 105 to the owner of the data and those authorized by the owner.

System 100 may further include one or more client devices 111, 113, and 115 coupled to server 107 via network 109, which may include the Internet or any other public or private network. Client devices 111, 113, and 115 may include any computing device, such as a handheld PDA, laptop, desktop, mobile phone, tablet computer, or the like, and users of client devices 111, 113, and 115 may include individuals (e.g., users, clients, and participants, etc.) belonging to a social network, experts (e.g., professionals, care providers, etc.) belonging to expert networks, businesses (e.g., organizations, companies, traders, etc.) belonging to a marketplace, or any other provider or consumer of private personal data. Using client devices 111, 113, and 115, users may access server 107 via secure and authenticated communication to upload, download, access, edit, or delete personal data in databases 101, 103, and 105. For example, the data stored in databases 101, 103 and 105 may be queried by transmitting a request by client devices 111, 113, and 115 to server 107 to access some or all of the stored data. In some examples, user interfaces may be provided by client devices 111, 113, and 115 to allow users to enter their queries of the data and to view the results of the queries. In some examples, the query results may be presented to a user in a manner that allows for interpretation of the user's data in the context of his/her own data, his/her network of users, all users of the system, or other subsets of users. For example, in some instances, only the user's data may be returned or evaluated in response to a query. In another example, data associated with users within the user's network may be returned or evaluated in response to a query. In yet another example, all data stored in the system may be returned or evaluated in response to a query. The transmission of data may be partially or fully anonymous, private, encrypted, time-stamped, or authenticated.

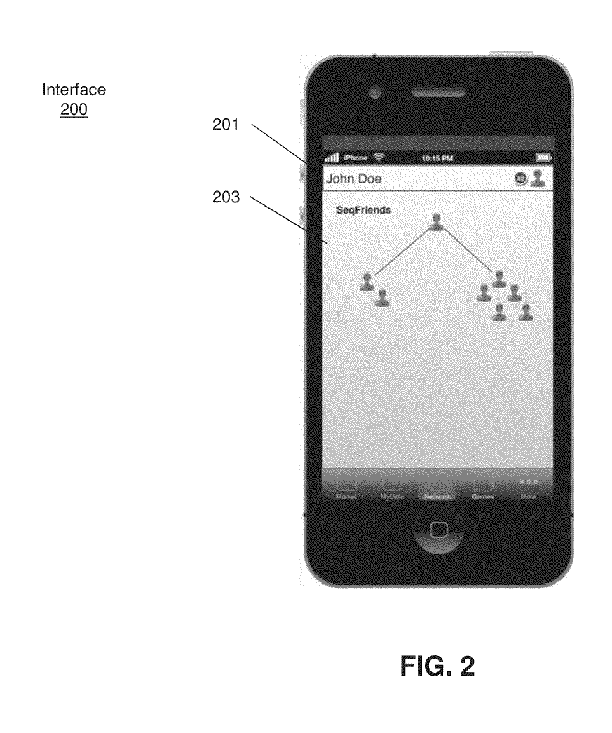

In some examples, as shown in FIG. 2, client devices 111, 113, and 115 may be configured to display a user interface 200 showing a user's network. Interface 200 may include a field for username 201 identifying the user and network portion 203 for viewing the user's network according to user defined criteria (e.g. relatedness, geographic proximity, health parameters, etc.).

In some examples, client devices 111, 113, and 115 may be further configured to provide a user interface for allowing the user to enter their user name and password to authenticate with server 107 and to securely input and access data (e.g., via URLs with SQL structures embedded in the url). All state information may be maintained in the actual http or https message. In response to requests made using the user interface, requests to server 107 may be made through stateless requests embodying all necessary information needed to respond to the query. Results from the http- or https-based queries may be passed back to the client and displayed to the user. In some examples, the user interface may be presented to the user by a client application created in HTMI, and Javascript and viewed using a standard browser, such as Chrome, Firefox, Internet Explorer, Safari, and the like. In other examples, the user interface may be presented to the user by a downloadable computer program (a client process, e.g., source-code, or compiled binary, etc. in the form of an application, open-source library of analytics, etc.).

In some examples, a user may download a computer program (e.g., source-code, compiled binary, etc., in the forms of apps, open-source library of analytics, etc.) to their client device 111, 113, or 115 in order to analyze the user's local data, collect data from the user or other devices, manipulate (e.g., compress, encrypt, or perform privacy-preserving transformations) data, etc. In some examples, a client process (e.g., in the form of an application) may run privately on the user's local data by accessing the user's local database and initiating verbal or non-verbal solicitations for status information (e.g., “How are you feeling?”) via the user's client device 111, 113, or 115. Depending on the answer and other user data (e.g., mental health, physical health, genetic information, risk of schizophrenia, etc.), the client process may initiate further solicitations and analyses, thereby providing a clear picture of the psycho-social state of the user. The user may then manually or automatically inform any members of the social network, experts, or markets, indicating that a user requires intervention or is a candidate for a study.

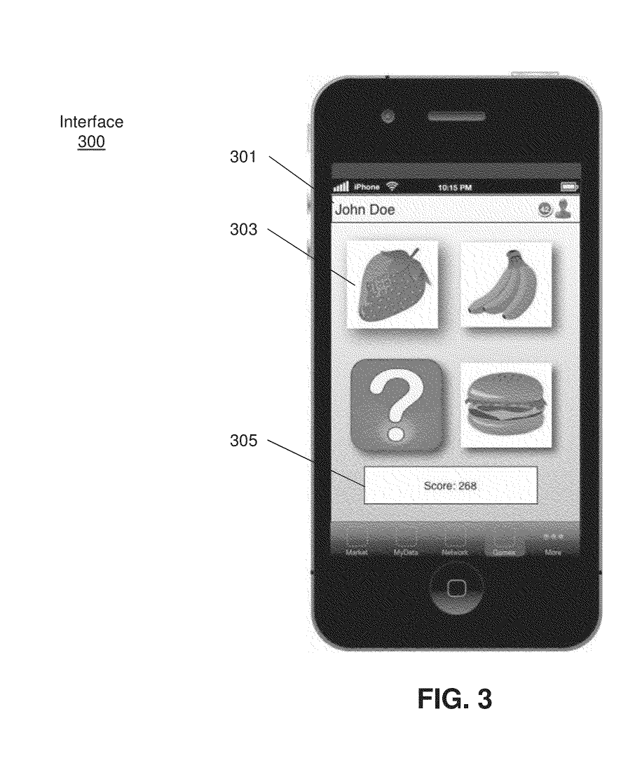

Another such client process (e.g., in the form of an application) may evaluate a user's symptoms, cognitive or sense (e.g., audio or visual) functions, trends, etc., through the use of electronic or non-electronic questionnaires, standardized tests, games, puzzles, etc., taken over a period of time. Such temporal or longitudinal data may be compared over time against itself or other groups (e.g., peers, age, and sex matched, etc.), and summarized. This information may be combined with personal data, medical data, and genetic information to inform a user about potential mental health risks and cognitive or sense (e.g., audio or visual) decline. Such analysis may be used to discover and develop biomarkers for a disease or a trait. FIG. 3 illustrates an example user interface 300 that may be provided by the client device for collecting user information according to various examples. Interface 300 may include a field for a username 301 identifying the user, a data collection field 303 for prompting users for information (e.g., images for collecting neurocognitive information), and a score 305 indicating a score for the user based on the answers provided in data collection portion 303. The input received in response to interface 300 may be stored in databases 101, 103, and 105 and associated with the user providing the responses.

In some examples, a user may be allowed to model, mine, simulate, analyze, and predict information from the user's private data as well as aggregated statistics. The results may be stored for future usage, sharing, marketing, etc. The analysis may be conducted under hypothetical situations and may be conducted in combination with shared data (e.g., genetic profile of a child that a couple may conceive, compatibility of a couple for marriage). The analysis may be used for personalization (e.g., in terms of a set of biomarkers; to find ethnic, genetic, or social group identity, etc.); for personalized medicine; for explanation (e.g., a causal explanation of why the user might have developed certain symptoms); for recommendation (e.g., a university to attend for higher education, an expert physician to see, partners to date with certain data features, etc.); for prediction; for prevention (e.g., steps to take to avoid early onset of type II diabetes); for hypothesis testing (e.g., clinical trial, evidence-based medicine, ADME analysis, drug toxicity, side effects); for scheduling tests; additional data-collection; etc.

In some examples, modeling of the data may be accomplished using a modeling tool that can be remote or local. The modeling tool may be executed with or without assistance of other members of the network and/or an expert (e.g., user's physician—including his expert network). The modeling tool can be an application downloaded and executed by the user's client device privately or in assistance with members of his network or an expert.

In some examples, system 100 may be implemented using a RESTful architecture for providing a stateless client-server and services communications protocol, generally using HTTP. In a RESTful design, each URL may be a unique object. This model provides a simpler architecture compared to the complexities of CORBA or SOAP for services or remote procedure calls. By using a RESTful design, a lightweight, agile, and flexible path for development of services and APIs that works on many platforms can be achieved.

In some examples, server 107 and databases 101, 103, and 105 may be configured to implement lossless or lossy data-compression techniques for all data access and processing, for example, to determine the statistics of occurrences of certain categories, genetic variants, frequency of certain phenotypes, etc. For example, the data may be stored in databases 101, 103, and 105 in a lossless manner by tracking differences from certain references or in a lossy manner by omitting certain details that are rare or that may be due to noisy measurements. Classical rate-distortion theory may be used to obtain desired trade-offs between the amount of data stored and the resulting loss of signal due to noise.

In some examples, server 107 may be configured to implement privacy-preserving techniques, such as techniques to achieve some forms of “differential privacy,” for all data access and processing, for example, to determine co-occurrences of certain genotypes and phenotypes, without revealing any other identifying features of the participants.

In some examples, server 107 may be configured to analyze the user data for data quality when the data is added to databases 101, 103, and 105 to allow metadata regarding quality to be stored. Since the data-quality may be dependent on the apparatus used to collect the data, filters and software pipelines used to preprocess the data, and error-correction and consensus-calling software used to post-process the data, the quality can be statistically de-convolved (e.g., using a machine-learning or Bayesian inference algorithm that hypothesizes a model of contributions from different components) to measure the contribution from each component and thus to assign a component-wise quality.

For example, to determine the quality of data in the system, server 107 may generally collect data from databases 101, 103, and 105 while preserving privacy and anonymity of the users, evaluate the data in terms of standardized metrics using statistical analysis tools for various qualities of service, and provide the results of the evaluation to the users and the other participants in a clear, timely and secure manner. In some examples, the data may include a statistically significant subsample of the data stored, complete datasets from a subset of users (with their permission/compliance), user surveys, user ratings, user-generated votes, expert opinions, market valuations, independent audit trails, etc. In some examples, the qualities may include the robustness, availability and privacy protection, provided by the data storage facility; accuracy (true-and false-positives/specificity and sensitivity, etc.) of the data generated by the instruments and technologies: sequencing platforms, sequence assembly algorithms, resequencing algorithms, GWAS algorithms, variant calls, gene-expression profiles, copy-numbers, dosage, epigenomic analysis, proteomic analysis, etc.; accuracy (true-and false-positives/specificity and sensitivity, etc.) of the results provided by the software tools (e.g., applications) for modeling, mining, simulating, analyzing and predicting from user data; training, trust, experience and service provided by the experts and expert networks; trust-worthiness, financial stability, or valuation and customer satisfaction of various organizations participating in the market.

In some examples, user data and metadata may be combined by server 107 to determine the consistency, truthfulness, possibility of breach of privacy or corruption by a malware, etc., of a user's data. For example, use of devices that provide location and activity information, such as GPS devices, smartphones, smartphone peripherals, etc., may be used to verify a patient's self-reporting and a scale transmitting weight information may corroborate a patient's view of his or her obesity or compliance with a program (e.g. clinical trial, weight loss, alcohol abstention, etc.). Further, the use of this and other personal data may be used by server 107 to alert a selected expert, family member, another member of his social network, market place, etc. Such a notification may or may not require the user's informed consent.

In some examples, instrument (e.g., biotechnical instruments, sequencing machines and their specifications, EEG, MEG, PE devices and their specifications, etc.) metadata may be analyzed and data quality may be stored in metadata based on metrics (e.g., specificity, sensitivity, accuracy etc., in data generated) for assessing instruments, software pipelines, filters, or subjective assessment. The analysis of data quality may be triggered manually, in temporal cycles, or in response changes to instrument metadata or assessments. For example, a new survey on sequencing machines may be sent out (1) if the chemistry was changed, (2) if predictions based on the sequence data begin to fail, or (3) done every three months. Triggers (1) and (2) are examples of manual and analysis triggers, respectively, and (3) is an example of a temporal cycle trigger.

In some examples, metadata may be analyzed by server 107 and maintained to validate assessments. Histories of analyses may be maintained and used to assess quality of data, such as accuracy, predictive power, etc. In some examples, access control lists may be maintained for each key-value pair or for groups of data such that other users can access data owned by a different user. Access control may be compared by server 107 with histories of analyses and used to assess the quality of data. Individual key-value pairs or groups of key-value pairs may be analyzed by server 107 based on the access control lists.

It should be appreciated that system 100 shown in FIG. 1 is provided only as an example and that variations to the system may be implemented. For example, while three databases and client devices are shown, it should be appreciated that any number of local or remote databases may be used and that system 100 may support any number of client devices. Additionally, while certain elements are shown as being singular or separate, it should be appreciated that some components of system 100 may be separated into multiple devices or combined into a single device. For example, server 107 may include multiple servers and one or more of databases 101, 103, and 105 may be included within one of these servers 107.

B. Matching Users with an Expert Network

Using a system similar or identical to system 100, described above, better utilization of private personal data for improved healthcare may be provided by one or more of experts. In these examples, system 100 may be used to (1) transmit personal data (e.g., stored in databases 101, 103, and 105) for use by a selected set of relevant experts while remaining compliant to patient privacy, federal regulations, and other ethical standards; (2) organize effective physical, virtual, or hybrid-combination sessions for interactions between one or more patients (e.g., in group therapy) and one or more members of their expert network; and (3) determine the quality of expertise and utility of care provided by an evidence-based analysis.

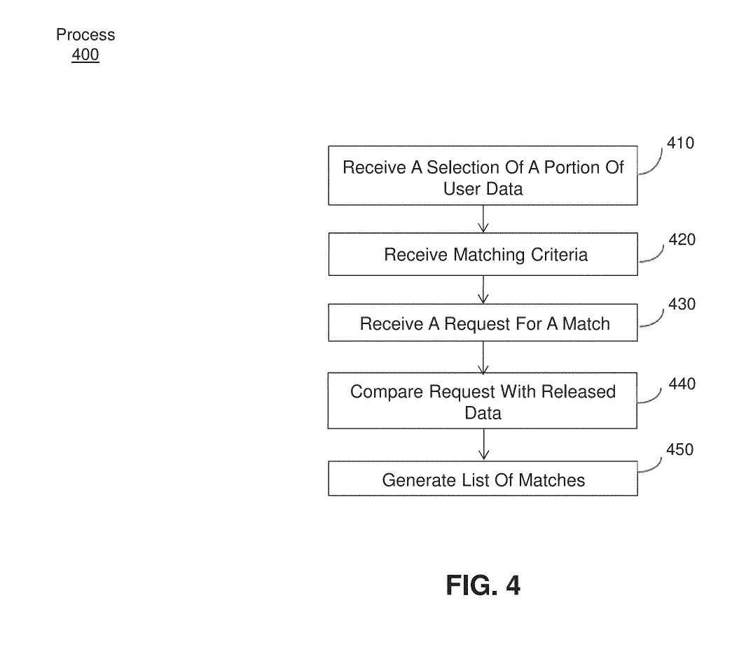

FIG. 4 illustrates an example process 400 for matching a user with one or more experts that may be performed using a system similar or identical to system 100. At block 410, a selection of at least a portion of a user's data (e.g., stored in databases 101, 103, and 105) to be anonymously released may be received (e.g., by server 107) from the user (e.g., via client device 111, 113, or 115). In some examples, the server may further receive a temporal limitation during which the selected portion of the user's data may be anonymously released. For example, an expert may maintain their record in a system database (e.g., databases 101, 103 and 105) as data and metadata (e.g., qualification, contact information, quality of care, cost of care, etc.) The expert may then select their qualification, quality of care, and cost of care at block 310 to be publicly released with no time limitation.

At block 420, one or more matching criteria (e.g., results, expertise, price) may be received by the server from the user. In some examples, the criteria may be translated into a mathematical score using, for example, a Bayesian inference algorithm that describes how two people may have originated from the same or two compatible populations. Blocks 410 and 420 may be performed any number of times for any number of users, such that the system may include multiple users that have anonymously released their data for the purpose of matching them with other users.

At block 430, a request for a match may be received by the server. The request may be received from the same user that released a portion of their data at block 410 and that provided matching criteria at block 420, or the request may be received from a different user. The request may include one or more matching criteria, such as specialty, qualifications, location, quality of care, cost of care, etc. For example, a patient may submit a request at block 430 to be matched with a nutritionist having a cost of care under a threshold amount.

At block 440, the parameters of the request received at block 430 may be compared with data that has been released by users at block 410. In some examples, user data (e.g., genetic markers, medical records, environmental data, etc.) of the requesting user may also be compared with the released data for purposes of determining a match at block 440. For example, user requests may be augmented with real-time biological, health, personal, behavioral, or location information from an electronic hardware, software, or combination of software and hardware, such as, but not limited to, smart phone, health monitoring device, GPS location, etc. Continuing with the example provided above, the data released by the expert at block 410 may be compared to the request received at block 430 to determine if the expert satisfies the user's request for a nutritionist having a cost of care under the threshold amount. A similar comparison may also be made with released data of some or all of the other users that have released their data at block 410. Based on these comparisons, an ordered list of matches between may be generated at block 450.

In some examples, the requesting user and/or the matches contained in the list may be notified of the determined potential match. For example, an anonymous and encrypted channel may be established between the requesting user of block 430 with the identified match(es) such that each can accept or reject the match for future interactions. If accepted, the system may initiate a meeting (e.g., face to face, voice, video, text, etc.) with a user. In some examples, this may include managing the actual data channels, storing some or all of the data in data channel, and allowing post-process (e.g., post-mortem) analysis. In some examples, the user or expert may provide feedback on the quality of a meeting, which could be recorded as metadata. An expert may initiate contact with the user based on data from the system if, for example, a manual or automatic predictive analysis of the user's data suggests a follow-up session.

In other examples, the requesting user of block 430 may be provided with metadata (e.g., contact information) associated with the one or more matched experts, thereby providing the user with a means of contacting the expert(s).

In some examples, users and experts may be allowed to share data based on access and privacy controls as, for example, determined by social norms (e.g., patient-client confidentiality), ethical norms, financial norms, legal principles, government regulations (e.g., HIPAA standard), and the like. In these examples, the system may evaluate each request to transmit or share data to determine if the access and privacy controls are being satisfied. If they are not being satisfied, the system may generate a recommendation to transmit or share the data in a way the does. If the access and privacy controls are being satisfied, then the data may be transmitted or shared as requested. For example, the user may provide access to subset of his electronic health record stored in the system's databases to his physician to discuss the symptoms with other physicians; the results of such discussions to be stored only in user's designated storage space.

In some examples, experts may have ratings and reviews viewable to the public and a score card with user recommendations. The experts may pay the provider of system 100 a transaction fee for organizing and executing a session, collected either monthly, hourly, or by session. They may also determine and publish their own pricing that would be paid by the user (or user's insurance). The experts may also be capable of selling any of their products (e.g., books, ebooks, apps, etc.) to a user via regular or electronic mail using the same network, according to specific criteria, as determined by the member.

If requested and permitted, sessions may be recorded by the system server for both the member and expert, for which an associated fee may then be charged. Users may have the option of participating in studies (e.g., clinical trials) based on their profiles and selection through the network, and may provide suitably selected portions of the data (e.g., from a session) for a price as determined by a market, which will be described in the next section. Group sessions can be enabled and members of families, for example, could do a therapy session without being in the same location physically but connected through sessions. An integrated mental health care system, which may also use genomic data proactively, preventively or predictively, as described herein, may be available uninterruptedly to the individuals and experts for a suitable hourly fee.

By performing process 400 using system 100, users may be allowed to identify suitable experts. For example, in one scenario involving mental health professionals and patients with psychological disorder, the process may operate as follows: within the network, any mental health professional can create an account and utilize the database of members for targeting their specialties and the members' needs. The system may allow members to input/specify their mental health conditions based on their goal of selecting a suitable expert, e.g., a psychiatrist. Using that information, a mental health professional with the best fit may be introduced and eventually connected to the member. Members may get multiple options and matches based on their information and choose their own personal professional for any specialty.

In this scenario, once connected and introduced, the mental health professional may be able to initiate private therapy sessions with the member through a secure private voice or video chat. Within the chat interaction, with the permission of the user and the expert, appropriate correlated information (e.g., targeted advertisements or related reading materials) could be placed on the users' screen, matching the members interests and profile.

### C. Information-Based Market

A system similar or identical to system 100, described above, may also be used to provide transparent, liquid, fair, and flexible information-based marketplaces that are enabled by auctions, market-makers, and supply-and-demand-driven pricing and within which participants may create (with or without a direct association to money in any specific currency) rights and obligations to give each other full or limited access to their data within an infrastructure provided by secure social networks as well as secure peer-to-peer/peer-to business marketplaces. These marketplaces may have the ability to connect a large number of participants wishing to share certain elements of their personal data with other individuals, health care practitioners, businesses, or other entities that wish to purchase those select elements in a secure market place at known prices, which for example could be set by an auction, a market-maker(s), or a dynamic pricing model. In this way, a market can be established to monetize quality data resulting from data capture. For example, a system similar to a Nielsen rating system for sequence data can be established using some or all of the captured data described above.

For example, the market may allow buying and selling of data, a mechanism to price data, a mechanism for financial transactions—with fame, money, credits, points, tokens, or coupons, mechanisms for targeted advertisement, mechanisms for buy request at a price, mechanisms for buying data for a clinical trial, mechanisms for pricing health-insurance, mechanisms for preventive and predictive medicine with financial rewards for goals achieved, mechanisms for sale request, mechanisms for research studies (perhaps with non-financial rewards—e.g., fame), mechanisms for finding genetic distance relations among selected users (e.g., find me 25 Indians with similar biomarkers as mine and in his late 60's, and with a type-II diabetes onset at age 40). The market may further allow the user to conduct anonymous exchange of information to predict an organ-transplant donor, egg donor, sperm donor, dating, employees, animal models, genetic counseling, patient social groups, addiction social groups (e.g., AA), ancestry, paternity testing, or educational usage (a college class on personalized genomics).

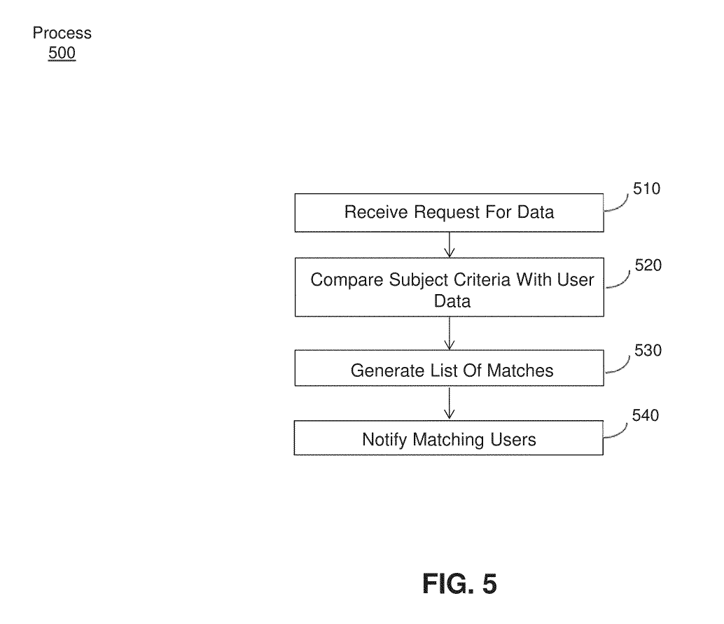

FIG. 5 illustrates an example process 500 for implementing an information-based marketplace using a system similar or identical to system 100, described above. Process 500 may be performed to utilize marketplace participant data for clinical trials, biomedical research, and discovery as well as proactive, predictive, preventive and personalized medicine, which can (a) identify and match a group of individuals whose personal physical, genetic, behavioral, or other personal profiles satisfy certain selection criteria with an institution or various institutions requiring additional datasets from such a group, thus enabling specific pairing of researcher and subject that is accompanied by knowledgeable, consented and transparent transaction between the parties, (b) determine, for example, through a bargaining, auction or market-clearance process, fair conditions, rewards, obligations and rights under which such transactions can be carried out, (c) carry out the selected transactions in an efficient, timely and compliant manner, and (d) evaluate the quality, e.g., compliance, truthfulness, trust, etc. using such methods as voting, auditing, consistency-checking, etc. of the parties involved in a transactions under various criteria.

At block 510, a request for user data may be received (e.g., by server 107) from a business, research institution, or individual (e.g., using client device 111, 113, or 115). The request may include one or more subject recruitment-specific criteria, such as individual phenotypic information, genetic information, current or prior history of disease, family medical history, demographic data, geographic information, prior therapies, prior involvement in clinical trials, current list of medications including vitamins and natural remedies being used, and the like. The subject criteria may further include a study price to be paid for data points based on the latest known market pricing for each selected data point. If a data point has no historical market price then one may be arbitrarily provided or a price may be appended to the data point based on market prices for similar data points. In some examples, the market may allow pricing to be based on revenue sharing where users can receive some pre-negotiated and agreed upon percentage of the revenue generated by the product in which their data was used. For example, the marketplace may allow reach-throughs to drugs and diagnostics revenue as well as a liquid market of futures and forwards on reach-throughs.

At block 520, the subject criteria may be compared with some or all of the user data stored in the system. For example, the comparison may be limited to data of users that have requested to be included in the market or may include all user data stored in the system. In some examples, a matching algorithm or study expert may be used to perform the comparison at block 520 to identify marketplace participants that match all or a portion of the subject criteria. In some examples, the matching algorithm used at block 520 may be rules-based, determined by a machine-learning algorithm or manually selected. The study coordinator, individual, business, or institution defining the subject criteria at block 510 may determine the desired accuracy of participant matches, thereby giving greater flexibility in matching to a desired participant pool. The rules-based study, for example, allows some studies within the marketplace to accept only those participant that match 100% of the study-specific criteria, while other studies may accept participants that match less than 100% of the study criteria. Further, study coordinators, individuals, businesses, or institutions may designate a partition of the data into multiple subgroups, e.g., two sets, consisting of core or required data where a 100% match is sought and optional data where less than a 100% match would suffice. A “match” would exist for a study if the study-specific data submitted by the participant successfully passes enough of the study's eligibility criteria to meet the specified percentage. The data market values may incorporate such factors such as core data and optional data.

In some examples, the individuals' data and the subject study-specific inclusion criteria may be stored in one or more separate databases (e.g., databases 101, 103, and 105) on one or more of separate servers. Additionally, the marketplace system may use security protocols to ensure that private data is kept confidential. The security application layer of the network may monitor all protocols that are sent back and forth to the databases and allows the marketplace to remain autonomous. The security application may send only the data necessary for matching participants to posted studies. The marketplace may include a secure database system that matches participants with appropriate studies while keeping proprietary study information hidden.

In some examples, the individuals that placed their personal data in the private database (e.g., databases 101, 103, and 105) may be able to see the value of each data point and the aggregate data value. The value may include, but is not limited to, fame, money, credits, points, tokens, coupons, or the like. This value may remain static or vary dynamically according to supply and demand or market forces.

In some examples, the marketplace and participant information may be protected from unauthorized access. The secure database system may use, for example, various malware detection algorithms to protect sensitive information on both the study and participant's personal data. The marketplace database system may include safeguards from hacking and spoofing, which is accomplished by using, for example, security protocols utilizing fine grain access control, highly redundant firewall/security systems, cloud-base storage of the most sensitive information as well as traditional safeguards such as for example, n-bit (e.g., n=256) Secure Socket Layer (“SSL”) encryption, unique identifiers, maximum number of requests per hour, and other similar schemes known to persons having ordinary skill in the art. Individuals' data are also protected in this controlled environment, and will only be released by the marketplace participants' active consent.

At block 530, the server may generate a list of matching users based on the comparison performed at block 520. In this way, the study coordinator, individual, business, or institution may be able to assess at any given time the number of individuals whose private personal data match their study-specific inclusion criteria. Additionally, the study coordinator, individual, business, or institution may be able to estimate the cost of their subject recruitment based on the data value and the estimated number of individuals who would qualify (or both qualify and participate) for a given study.

At block 540, the system may then send the matching participant(s) a notification via electronic message, text message, phone call, e-mail or other means of communication. The communication may include a reason for the contact, summary of the study or trial, and confirmation that the study or trial provider is willing to enter into a monetary or non-monetary transaction based on the prevailing market rates for the data sought in the study-specific inclusion criteria. The individual may then elect to contact the study or trial provider directly or through a secure and/or anonymous or pseudonymous network. The individual may be paid money or points for the act of opening the email message or electing to participate. In some examples, the market may allow a recruited user to create an informed consent that can be based on publicly available information, expert-network provided information and specific study-related information provided and determined by the study-coordinator. Such an informed consent could be kept by the user in his own data storage and can be used multiple times for a sequence of studies. The marketplace may charge an appropriate service fee for coordinating consent data.

In some examples, users may post observations and discuss matters directly or indirectly related to data; vote on questions and observations arising from such discussions; express approval (like or dislike) of an observation, conclusion, prediction, etc.; augment approval or vote with comments; or query and receive answers related to the data.

In some examples, participants may form groups for the purposes of collective bargaining with individuals or businesses seeking to conduct business. For example, a group may be able to collectively bargain to share their collective data for a study in return for having a second study conducted of their choosing.

In some examples, users may dynamically architect forms, features, social-, ethical- and commercial-norms of their social networks, expert networks or markets either globally or in individually defined sub-social networks, sub-expert networks or protected markets. For example, individuals may filter inputs according to certain agreed-upon norms in order to favorably affect their bargaining positions (e.g., an individual's health or life insurance premiums that could be dependent on an individual's genetic markers).

Using process 500, individuals can opt-in to one or more marketplaces and receive notifications for population-based research studies for which their personal data or a sub-set of their personal data along with the data for other genetically (similarly, environmentally or microbiomically) related family members may be suitable under the study-specific inclusion criteria.

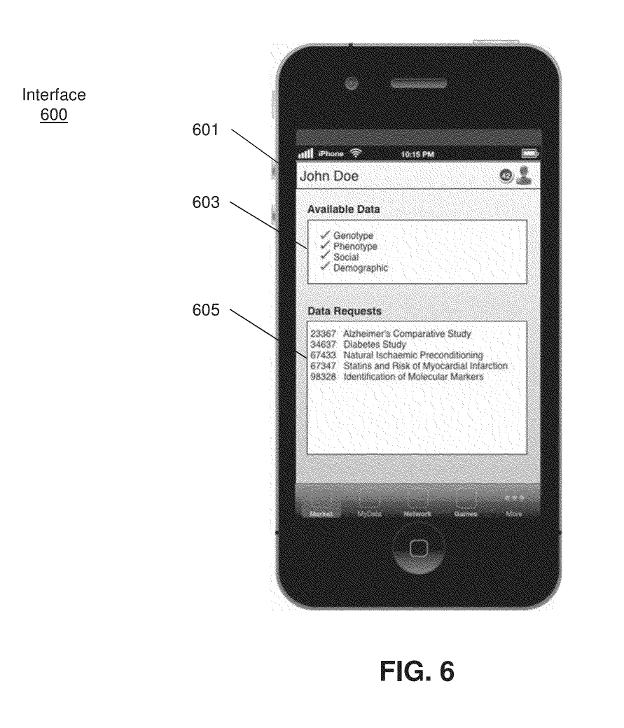

FIG. 6 illustrates an example user interface 600 for an information-based clinical trials market that can be displayed to a user using a client device, such as client device 111, 113, or 115. Interface 600 may include a field for username 601 identifying the user, available data types 603 (e.g., the user has made available genotype, phenotype, social, and demographic data), and data request 605. In the illustrated example, the user is eligible for six studies based on the user making available the listed available data types 603 and/or the user meeting selection criteria. Specifically, the user has received data requests from the “Alzheimer's Comparative Study,” “Diabetes Study,” “Natural Ischaemic Preconditioning,” “Stains and Risk of Myocardial Infarction,” and “Identification of Molecular Markers.” While viewing this screen, no identifier data has yet been exchanged.

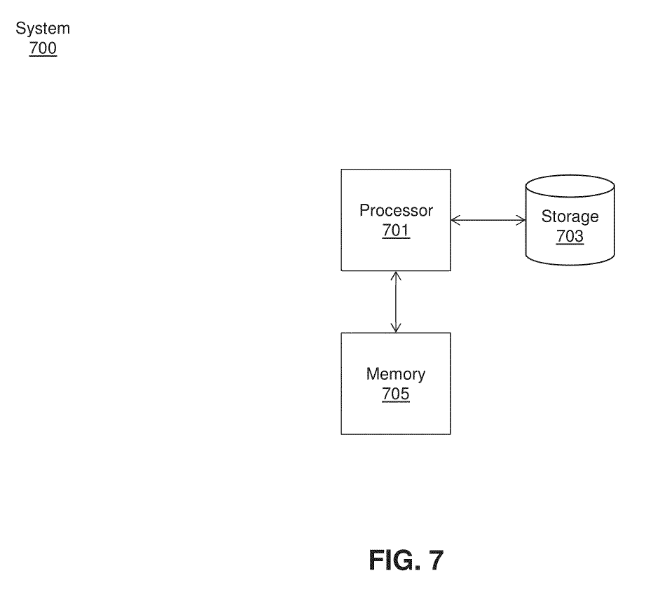

FIG. 7 illustrates a block diagram of exemplary system 700 that may be included within server 107 of system 100. System 700 may include a processor 701 for performing some or all of the processes described above, such as process 400 or 500. Processor 701 may be coupled to storage 703, which may include a hard-disk drive or other large capacity storage device. System 700 may further include memory 705, such as a random access memory.

In some examples, a non-transitory computer-readable storage medium can be used to store (e.g., tangibly embody) one or more computer programs for performing any one of the above-described processes by means of a computer. The computer program may be written, for example, in a general purpose programming language (e.g., Pascal, C, C++) or some specialized application-specific language. The non-transitory computer-readable medium may include storage 703, memory 705, embedded memory within processor 701, an external storage device (not shown), or the like.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this disclosure.

1-10. (canceled)

11. A non-transitory computer readable storage medium comprising computer code for managing personal data within a network, the computer code comprising instructions for:
storing user data for a plurality of users in one or more databases;
receiving a request for a subset of the user data, wherein the request comprises one or more subject criteria and a price to be paid for the subset of user data;
comparing the one or more subject criteria with user data associated with at least a portion of the plurality of users to identify a matching set of users; and
sending a notification to the users of the matching set of users indicating that a match has been detected between the request for the subset of the user data and their respective user data.

12. The non-transitory computer readable storage medium of claim 11, wherein the computer code further comprises instructions for receiving, from a user of the matching set of users, an authorization to share at least a portion of the user's data with an entity submitting the request for the subset of the user data in exchange for a financial or non-financial reward, wherein the financial or non-financial award is based at least in part on the price to be paid for the subset of user data defined by the request.

13. The non-transitory computer readable storage medium of claim 11, wherein the user data comprises one or more of genome wide sequences, sequence related metadata, electronic healthcare data, biological data, demographic data, medical data, and other biomedical data.

14. The non-transitory computer readable storage medium of claim 11, wherein the price to be paid for the subset of user data comprises a known price for a type of the subset of user data, a price for a similar type of data, or an arbitrarily selected price.

15. The non-transitory computer readable storage medium of claim 11, wherein identities of the plurality of users are not revealed to an entity submitting the request for the subset of the user data when comparing the one or more subject criteria with the user data associated with the at least a portion of the plurality of users.

16. A non-transitory computer readable storage medium comprising computer code for managing personal data within a network, the computer code comprising instructions for:
storing user data for a plurality of users in one or more databases, wherein the user data comprises medical data;
receiving, from a first user of the plurality of users, a request to be matched to a second user of the plurality of users, wherein the request comprises one or more matching criteria, and wherein the second user comprises a heath care professional;
comparing the one or more matching criteria with user data associated with data associated with at least a portion of the plurality of users to identify a matching set of users from the at least a portion of the plurality of users, wherein the matching set of users comprises the second user; and
generating a ranked list comprising the matching set of users.

17. The non-transitory computer readable storage medium of claim 16, wherein the computer code further comprises instructions for transmitting a notification to the first user and at least a portion of the matching set of users indicating that a match has been detected between the first user and at least a portion of the matching set of users.

18. The non-transitory computer readable storage medium of claim 17, wherein the computer code further comprises instructions for:
receiving, from the first user, a selection of the second user;
receiving, from the second user, a selection of the first user; and
facilitating communication between the first user and the second user.

19. The non-transitory computer readable storage medium of claim 16, wherein the computer code further comprises instructions for comparing user data associated with the first user with user data associated with other users to identify potential mental health risks, potential cognitive decline, or potential sense decline.

20. The non-transitory computer readable storage medium of claim 16, wherein each of the at least a portion of the plurality of users is a health care professional, and wherein the at least a portion of the plurality of users authorized their associated user data to be publicly available.

21. A system for managing personal data within a network, the system comprising:
one or more databases configured to store user data for a plurality of users; and
a server communicatively coupled to the one or more databases, wherein the server comprises a computer processor configured to:
receive a request for a subset of the user data, wherein the request comprises one or more subject criteria and a price to be paid for the subset of user data;
compare the one or more subject criteria with user data associated with at least a portion of the plurality of users to identify a matching set of users; and
cause transmission of a notification to the users of the matching set of users indicating that a match has been detected between the request for the subset of the user data and their respective user data.

22. The system of claim 21, wherein the processor is further configured to receive, from a user of the matching set of users, an authorization to share at least a portion of the user's data with an entity submitting the request for the subset of the user data in exchange for a financial or non-financial reward, wherein the financial or non-financial award is based at least in part on the price to be paid for the subset of user data defined by the request.

23. The system of claim 21, wherein the user data comprises one or more of genome wide sequences, sequence related metadata, electronic healthcare data, biological data, demographic data, medical data, and other biomedical data.

24. The system of claim 21, wherein the price to be paid for the subset of user data comprises a known price for a type of the subset of user data, a price for a similar type of data, or an arbitrarily selected price.

25. The system of claim 21, wherein identities of the plurality of users are not revealed to an entity submitting the request for the subset of the user data when comparing the one or more subject criteria with the user data associated with the at least a portion of the plurality of users.

26. A system for managing personal data within a network, the system comprising:
one or more databases configured to store user data for a plurality of users, wherein the user data comprises medical data; and
a server communicatively coupled to the one or more databases, wherein the server comprises a computer processor configured to:
receive, from a first user of the plurality of users, a request to be matched to a second user of the plurality of users, wherein the request comprises one or more matching criteria, and wherein the second user comprises a heath care professional;
compare the one or more matching criteria with user data associated with data associated with at least a portion of the plurality of users to identify a matching set of users from the at least a portion of the plurality of users, wherein the matching set of users comprises the second user; and
generate a ranked list comprising the matching set of users.

27. The system of claim 26, wherein the processor is further configured to cause transmission of a notification to the first user and at least a portion of the matching set of users indicating that a match has been detected between the first user and at least a portion of the matching set of users.

28. The system of claim 27, wherein the processor is further configured to:
receive, from the first user, a selection of the second user;
receive, from the second user, a selection of the first user; and
facilitate communication between the first user and the second user.

29. The system of claim 26, wherein the processor is further configured to compare user data associated with the first user with user data associated with other users to identify potential mental health risks, potential cognitive decline, or potential sense decline.

30. The system of claim 26, wherein each of the at least a portion of the plurality of users is a health care professional, and wherein the at least a portion of the plurality of users authorized their associated user data to be publicly available.
